(19) United States
(12) Patent Application Publication
(10) Pub. No.: US 2019/0118065 A1
(43) Pub. Date: Apr. 25, 2019

(54) TRAINING SYSTEM AND A METHOD OF USING SAME

(71) Applicant: LedSwim Ltd.., Nir-Zvi (IL)

(72) Inventor: Noam KERTES, Nir-Zvi (IL)

(73) Assignee: LedSwim Ltd., Nir-Zvi (IL)

(21) Appl. No.: 16/098,870

(22) PCT Filed: May 3, 2017
(86) PCT No.: PCT/IL2017/050488

§ 371 Date: Nov. 5, 2018

Related U.S. Application Data
(60) Provisional application No. 62/332,001, filed on May 5, 2016.

(51) Int. Cl. A63B 71/06; A63B 69/12; G09B 19/00

(52) U.S. Cl. CPC A63B 71/0619; A63B 69/12; A63B 71/06; G09B 19/0038; A63B 2225/54; A63B 2071/0694; A63B 2207/02; A63B 2225/20; A63B 2225/50; A63B 2071/0658

(57) ABSTRACT

A training system for athletes may include at least one signaling unit, at least one lane management unit and a facility management unit. The at least one signaling unit may include a mounting device attachable to a surface of a training facility, an indicators carrier, attachable to the mounting device. The mounting device may be configured to receive and retain at least two strips of indicators each strip comprising a plurality of light indicators. The at least one lane management unit may include an input device, an output device, a processor and a communication unit in active communication with the signaling unit. The facility management unit may include a communication channel configured to communicate with the at least one lane management unit and with a remote server computer and at least one processor. The light indicators, may be adapted to present a progressing light indication.

### BACKGROUND OF THE INVENTION

Amateur and professional athletes have a growing need to plan, measure, manage and monitor their training sessions. Furthermore, athletes are interested in receiving instructions and guidance during a practice as to which type of exercise to do, for how long, in what pace, when to take a rest, when to restart session and the like. Athletes are also interested in monitoring their progress as well as their position with respect to their friends.

Training facilities, such as gyms, swimming pools, stadiums and the like, are interested in maximizing the usage of their training lanes and workout equipment. Thus, may wish to coordinate the start times, rest times and the like of a plurality of trainees using the same lane or equipment.

### SUMMARY OF THE PRESENT INVENTION

Some embodiments of the invention may be related to a training system for athletes. The training system may include at least one signaling unit, at least one lane management unit and a facility management unit. In some embodiments, the at least one signaling unit may include a mounting device attachable to a surface of a training facility, an indicators carrier, attachable to the mounting device. The mounting device may be configured to receive and retain at least two strips of indicators each strip comprising a plurality of light indicators. In some embodiments, the at least one lane management unit may include an input device, an output device, a processor and a communication unit in active communication with the signaling unit. In some embodiments, the facility management unit may include a communication channel configured to communicate with the at least one lane management unit and with a remote server computer and at least one processor. In some embodiments, the light indicators, in operation, may be adapted to present a progressing light indication, the progressing light indication characteristics may be indicative of the training program of the athlete.

In some embodiments, the progressing light indication characteristics may include at least two of a list consisting of: light progress speed; light color; light intensity; light color shade variation; and light pattern. In some embodiments, the indicators carrier may be attachable to the mounting device in a first position and in a second position such that the first position the indicators may be exposed and in the second position the indicators may be enclosed between the carrier and the mounting device.

In some embodiments, the input device of the at least one lane management unit may be at least one of: a Near Field Communication (NFC) tag reader, and an RFID reader. In some embodiments, the input device may be adapted to identify an athlete and send the identity of the athlete to the facility management unit via the communication channel. In some embodiments, the output device may be a screen, such as for example, a touchscreen.

In some embodiments, the facility may be a swimming pool and the mounting device is attachable to a bottom of the pool. In some embodiments, the training program may include at least one of a swimming style, swimming speed, number of repetitions, progress in session, duration of training session and duration of rest periods.

In some embodiments, the server computer may include a processor, a memory and an input device. In some embodiments, the server computer may be in active communication with the at least one facility management unit. In some embodiments, the server computer may further be in active communication with one or more user devices, such that the server computer may be adapted to store on the memory one or more training programs received from the at least one user devices. In some embodiments, the server computer may be adapted to send to one of the at least one facility management units a stored training program of an athlete. In some embodiments, the facility management unit may be adapted to receive the training program of the athlete according to the identity of the athlete sent to the remote server computer from the facility management unit.

Some embodiments of the invention may be related to a method of training athletes. Embodiments of the method may include: receiving at a facility management unit, a first trainee's training program and at least a second trainee's training program, determining, by the facility management unit, the location of the first trainee along training lane and determining based on the location of the first trainee along the lane, the first trainee' s training program and the at least second trainee's program, an at least second time instance to launch the second trainee's training session.

In some embodiments, the method may further include receiving an indication regarding the location of each of the trainees along the lane and adjusting light indications progress pace to maintain at least a minimal predefined distance between the trainees in the lane.

Some embodiments of the invention may be related to a method of training athletes. Embodiments of the method may include receiving, via an input device of a lane management unit, an identity of at least one athlete, receiving at the lane management unit a training program of the identified athlete, from a facility management unit and presenting, by a light indicator, a progressing light indication along the lane, the progressing light indication characteristics are indicative of the training program.

In some embodiments, the light indicator may include a plurality of LED strips parallel to each other and deployed along at least a portion of the lane. In some embodiments, the input device may be at least one of: a Near Field Communication (NFC) tag reader, and an RFID reader. In some embodiments, the training program may be received from a server computer in active communication with the facility management unit. In some embodiments, the server computer may be in active communication with one or more user devices, the server computer may be adapted to store on a memory one or more training programs received from the at least one user devices.

In some embodiments, the progressing light indication characteristics may include at least two of a list consisting of: light progress speed, light color, light intensity, light color shade variation; and light pattern.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram of a system according to embodiments of the present invention;

FIG. 2A is a schematic exploded view of a signaling unit according to embodiments of the present invention;

FIGS. 2B, 2C, 2D and 2E are illustrations of alternative installations of a signaling unit according to embodiments of the present invention;

FIGS. 3A, 3B and 3C are illustrations of different light indications according to embodiments of the present invention;

FIG. 3D is an illustration of progressing light indications for a plurality of athletes according to embodiments of the present invention;

FIG. 4 is a flowchart of a method according to some embodiments of the present invention; and

FIG. 5 is a flowchart of a method for training athletes according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

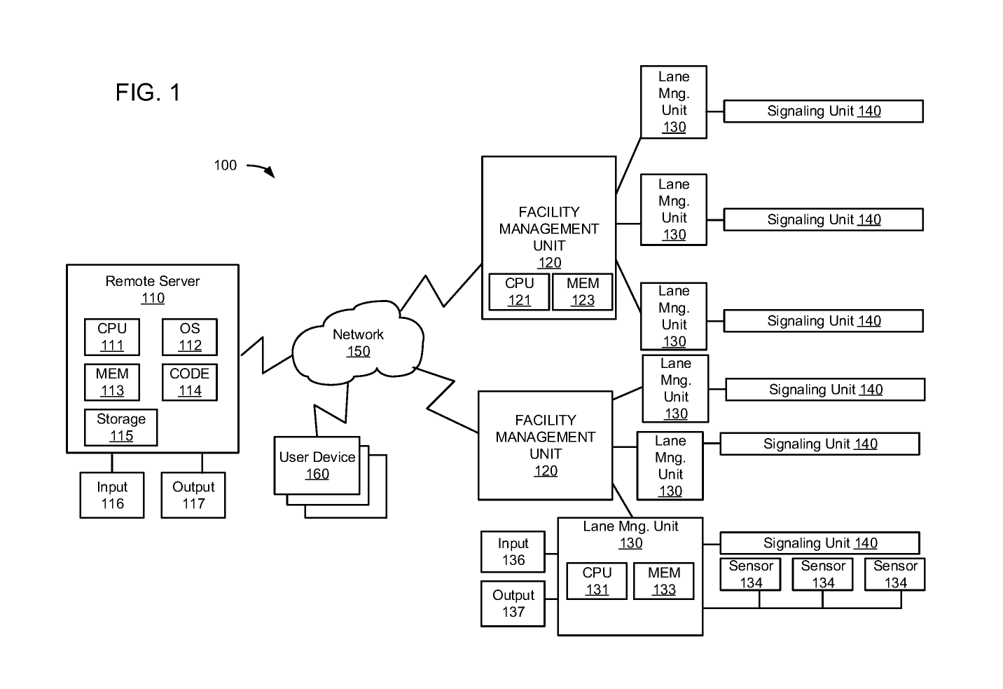

Reference is now made to FIG. 1 which is a block diagram of a training system 100 according to embodiments of the present invention. According to some embodiments, training system 100 may include at least one signaling unit 140; at least one lane management unit 130; and a facility management unit 120.

According to some embodiments, system 100 may further include a remote server 110, in active communication, via a network 150, such as the Internet, with at least one facility management unit 120 in at least one facility. According to some embodiments, server 110 may further be in active communication with one or more user devices 160, such as laptop computers, smartphones, tablets, desktop computers and the like, via network 150.

According to some embodiments, server 110 may include a controller 111 that may be, for example, a central processing unit processor (CPU), a chip or any suitable computing or computational device, an operating system 112, a memory 113, an executable code 114, and a storage 115. According to some embodiments, server 110 may further include input devices 116 and/or output devices 117. Controller 111 may be configured to carry out methods described herein, and/or to execute or act as the various modules, units, etc. More than one server 110 may be included in system 100.

Operating system 112 may be or may include any code segment (e.g., one similar to executable code 114 described herein) designed and/or configured to perform tasks involving coordination, scheduling, arbitration, supervising, controlling or otherwise managing operation of server 110, for example, scheduling execution of software programs or enabling software programs or other modules or units to communicate. Operating system 112 may be a commercial operating system.

Memory 113 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 113 may be or may include a plurality of, possibly different memory units. Memory 113 may be a computer or processor non-transitory readable medium, or a computer non-transitory storage medium, e.g., a RAM.

Executable code 114 may be any executable code, e.g., an application, a program, a process, task or script. Executable code 114 may be executed by controller 111 possibly under control of operating system 112. For example, executable code 114 may be an application that coordinate training sessions of two or more athletes in a single training lane as further described herein. Although, for the sake of clarity, a single item of executable code 114 is shown in FIG. 1, a system according to embodiments of the invention may include a plurality of executable code segments similar to executable code 114 that may be loaded into memory 113 and cause controller 111 to carry out methods described herein.

Storage 115 may be or may include, for example, a hard disk drive, a floppy disk drive, a Compact Disk (CD) drive, a CD-Recordable (CD-R) drive, a Blu-ray disk (BD), a universal serial bus (USB) device or other suitable removable and/or fixed storage unit. Content, such as training program, may be stored in storage 115 and may be loaded from storage 115 into memory 113 where it may be processed by controller 111. In some embodiments, some of the components shown in FIG. 1 may be omitted. For example, memory 113 may be a non-volatile memory having the storage capacity of storage 115. Accordingly, although shown as a separate component, storage 115 may be embedded or included in memory 113. According to some embodiments, storage 115 may store training programs of a plurality of athletes (also referred to as trainees or users). According to some embodiments, storage 115 may store information associated with one or more athletes, such as, for example, identification number, name, address, gender, athlete training goals (as may be set for example, by the athlete or by his trainer or coach), training schedule (e.g. days of training, hours of training, etc.) and the like.

According to some embodiments, server 110 may further include input devices 116, such as a mouse, a keyboard, a touch screen or pad or any suitable input device. It will be recognized that any suitable number of input devices may be operatively connected to 110. It should be appreciated that according to some embodiments, server 110 may not include input devices 116 and may receive all inputs from other units of system 100 such as, for example, user devices 160 and facility management units 120.

Output devices 117 may include one or more displays or monitors, speakers and/or any other suitable output devices. It will be recognized that any suitable number of output devices may be operatively connected to server 110 as shown by block 117. It should be appreciated that according to some embodiments, server 110 may not include output devices 117 and may send all outputs to other units of system 100 such as, for example, user devices 160 and facility management units 120. Any applicable input/output (I/O) devices may be connected to server 110 as shown by blocks 116 and 117. For example, a wired or wireless network interface card (NIC), a printer, a universal serial bus (USB) device or external hard drive may be included in input devices 116 and/or output devices 117.

According to some embodiments, one or more user devices 160 may be in active communication with server 110 via a network such as the Internet and may be used as an input device to create, edit, update and/or delete a training program of the user associated with the user device or by other users authorized by the trainee associated with a training program to create, modify and/or delete the trainee's training program, such as an authorized trainer, authorized by his trainees to modify each of their training programs stored in storage 115 of server 110. According to some embodiments, facility management unit 120 may receive a training session program from server 110 once a user is identified by lane management unit 130. According to some embodiments, during a training session, and/or at the end of a training session, facility management unit 120 may update the training program of the trainee with the results (e.g., duration of training session, distance reached, average pace, compliance with training session program, and the like) of the training session. It should be appreciated that user device 160 may also be used as a display to provide information to the user of his or her training program, his or her progress and the like. User device 160 may have a dedicated application to allow access to server 110 and to allow creating and modifying training programs and viewing information regarding a trainee's training data stored on storage 115 of server 110.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 113, computer-executable instructions such as executable code 114 and a controller such as controller 111.

Some embodiments may be provided in a computer program product that may include non-transitory machine-readable medium, stored thereon instructions, which may be used to program a computer, controller, or other programmable devices, to perform methods as disclosed herein. Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including, semiconductor devices such as read-only memories (ROMs) and/or random access memories (RAMs), flash memories, electrically erasable programmable read-only memories (EEPROMs) or any type of media suitable for storing electronic instructions, including programmable storage devices. For example, in some embodiments, memory 113 is a non-transitory machine-readable medium.

According to some embodiments, lane management unit 130 may include a controller 131 (e.g. similar to controller 111 of server 110), a memory 133 (similar to memory 113 of server 110), one or more input devices 136, such as a keyboard, a mouse, a touchscreen, a Near Field Communication (NFC) card reader, an RFID tag reader, a USB port and the like, and one or more output devices 137 such as a screen, speakers and the like. According to some embodiments controller 131 may be a display controller adapted to control the operation of one or more output devices 137.

According to some embodiments, lane management unit 130 may be operationally connected to signaling unit 140 deployed along the lane associated to lane management unit 130. According to some embodiments, each lane management unit 130 may be in operational communication with facility management unit 120 via wired or wireless communication.

According to some embodiments, facility management unit 120 may not be required and each lane management unit 130 may be in direct communication with server 110 via network 150. It will be recognized that in such embodiments, lane management unit 130 may further include a wireless or wired connection to a network, such as the Internet. According to other embodiments, lane management unit 130 may not be required and facility management unit 120 may be in active communication with a plurality of signaling units 140, each signaling unit 140 deployed in a training lane, such as a running lane, a swimming lane and the like. In yet another embodiment, lane management unit 130 may be integral to or included in facility managing unit 120.

According to some embodiments, lane management unit 130 may include or may be in active communication with one or more sensors 134, such as one or more cameras, one or more ultrasonic sensors, and the like. One or more sensors 134 may be configured to collect readings from the lane associated with lane management unit 130, the readings may be indicative of the location of a trainee along the lane. According to some embodiments, one or more sensors 134 may be embedded in or connect to signaling unit 140 (e.g. embedded in indicators strip).

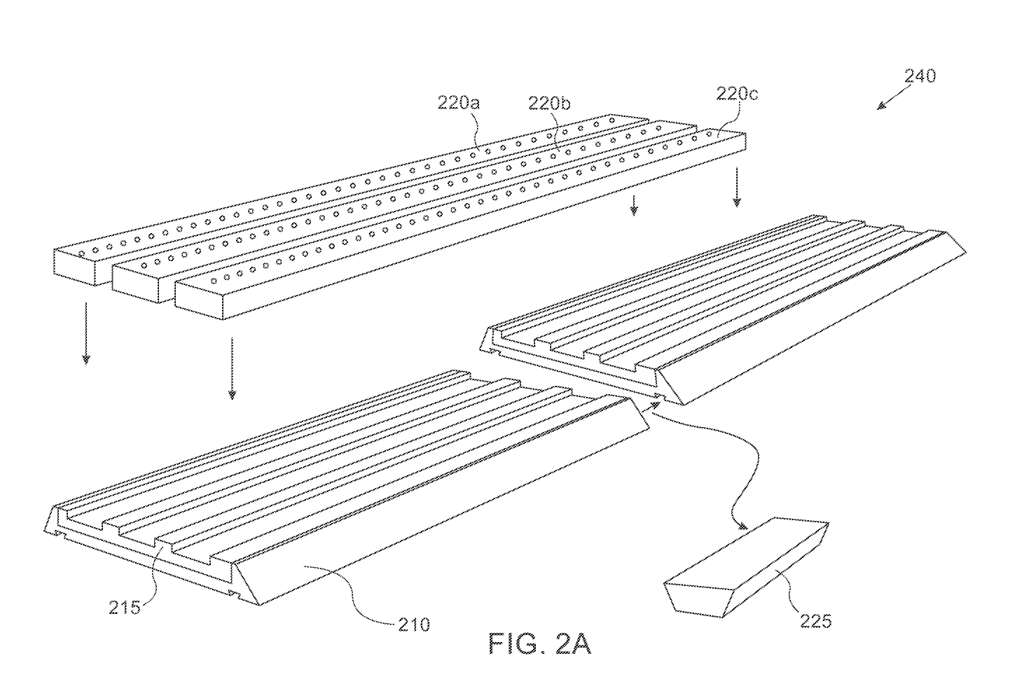

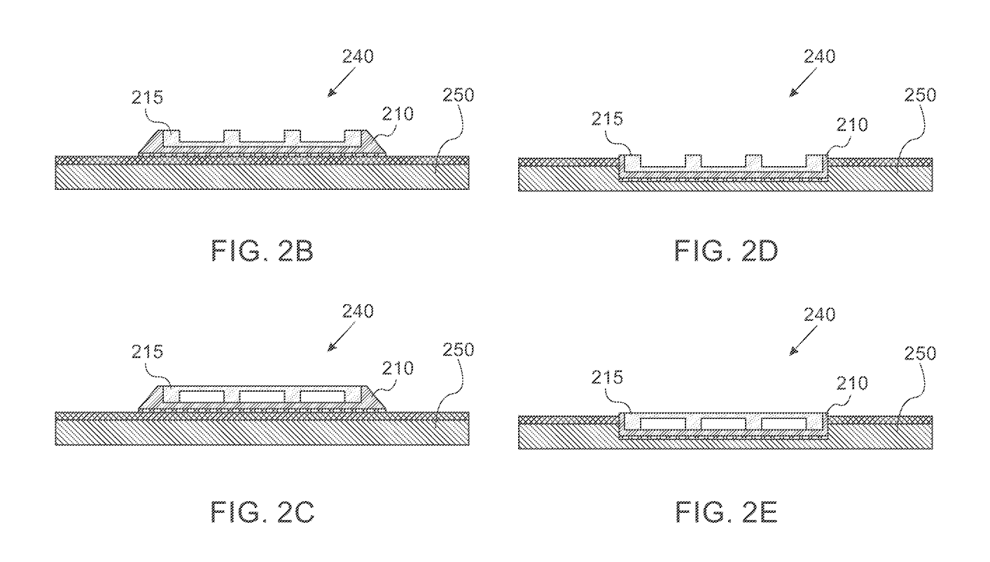

With reference to FIG. 2A, according to some embodiments, each signaling unit 140 may include a mounting device 210 attachable to a surface of a training facility (e.g. a bottom of a pool, along a running lane, a riding lane etc.) an indicators carrier 215, attachable to mounting device 210 and configured to receive and retain at least two strips of indicators 220a, 220b, 220c, such as Light Emitting Diode (LED) strip, each strip comprising a plurality of light indicators. According to some embodiments, the light indicators may be adapted to present to an athlete a progressing light indication, the progressing light indication characteristics may be indicative of the training program of the athlete.

According to some embodiments, mounting device(s) 210 may be connected to additional mounting devices by a connector 225 to create an elongated mounting device 210 in a required length.

Reference is now made to FIGS. 2B, 2C, 2D and 2E which are illustrations of alternative installations of signaling unit 240 according to embodiments of the present invention. As seen in FIGS. 2B and 2C, mounting device 210 of signaling unit 240 may be installed on an existing surface 250 of a training facility, such as a bottom of a swimming pool, along a running lane etc. According to some embodiments illustrated in FIGS. 2D and 2E, signaling unit 240 may be embedded in surface 250, during constructions or in a later stage.

According to some embodiments, indicators carrier 215 may be placed and retained in mounting device 210 in two different positions or orientations. in a first operational position (illustrated in FIGS. 2B and 2D) the indicators are exposed and are visible to an athlete in the lane and in the second storage position (illustrated in FIGS. 2C and 2E) the indicators are enclosed between the carrier and the mounting device and are not visible to an athlete in the lane. According to some embodiments, mounting device 210 and carrier 215 may be an integral unit having both functionalities (e.g. connecting to a surface of the training facility and receiving and retaining indicator strips 220a, 220b, 220c).

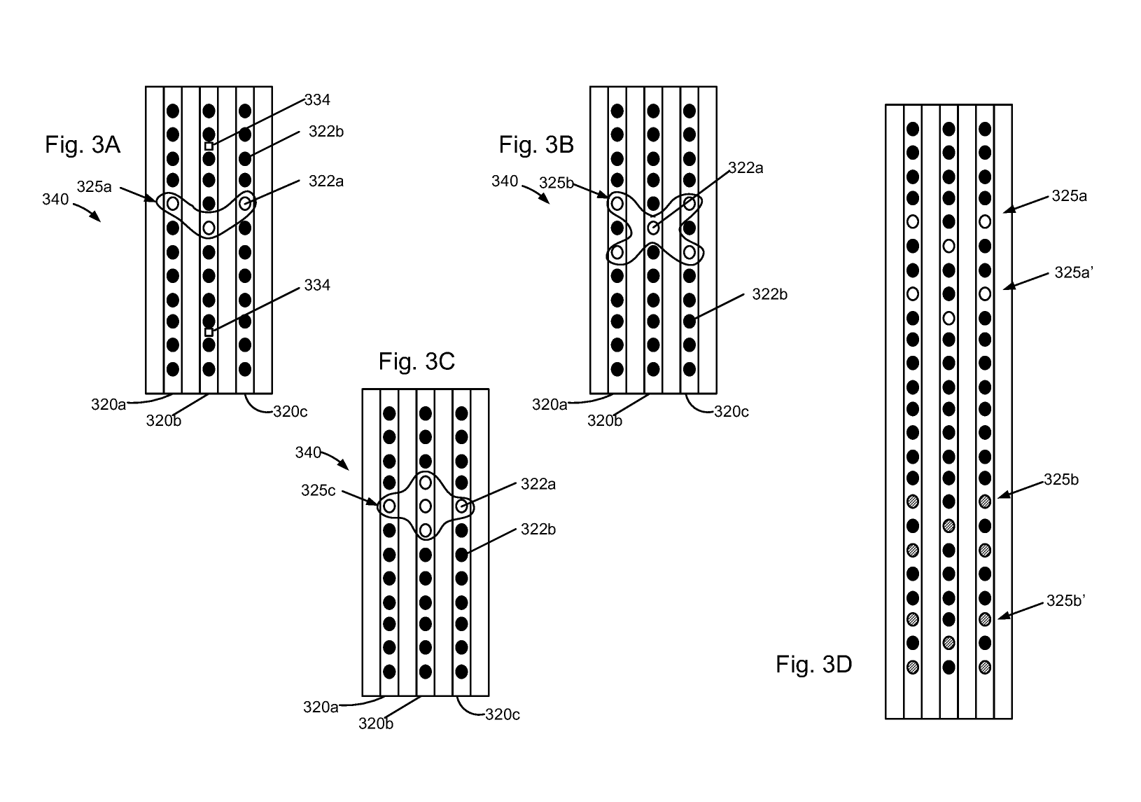

Reference is now made to FIGS. 3A, 3B and 3C which are illustrations of different light indications according to embodiments of the present invention. Signaling unit 340 may comprise a plurality of light signaling strips 320a, 320b, 320c, each strip 320a, 320b, 320c may include a plurality of illumination units 322a, 322b such as LED's. According to some embodiments, one or more of strips 320a, 320b, 320c may further include one or more sensors 334, such as one or more cameras, one or more ultrasonic sensors, a combination of cameras and ultrasonic sensors or any other sensor known in the art. According to embodiments of the present invention, a combination of illuminated units 322a and dark units 322b may create an illumination pattern 325a, 325b or 325c Illumination pattern 325a, 325b, 325c, and other illumination characteristics, such as illumination color, illumination progress speed, illumination intensity, illumination color change pattern etc., may be indicative of different parameters of a training program of an athlete. For example, the illumination pattern such as patterns 325a, 325b, 325c may indicate a training style, for example when used for training swimmers, the illumination pattern may indicate the swimming style (e.g. butterfly 325a, breaststroke 325b or crawl 325c). Accordingly, during a training session the swimmer may know when to switch swimming style according to the change in illumination pattern. According to some embodiments, each trainee in a lane may be assigned a different illumination color or range of colors. The progressing light indication or pattern characteristics may include one or more of: light pattern progress speed; light color; light intensity; and light pattern.

Reference is now made to FIG. 3D which is an illustration of progressing light indications or patters for one or more athletes in a single lane according to embodiments of the present invention. Light indication 325a may be a light indication for a first athlete in a lane, at time instance t₀ and light indication 325a′ may be the light indication for the first athlete in the lane at time instance t₁. Similarly, light indications 325b and 325b′ may be light indications at times t₀ and t₁ for another athlete in the same lane. As illustrated in FIG. 3D, each athlete in a lane may have a different light indication (e.g. different light pattern, different color etc.) and different light indication progress pace. For example, in FIG. 3D the pace of progress of light indication 325b during time T (T=t₁−t₀) is higher than the pace of progress of light indication 325a during the same time interval. Thus, distance Db between light indication 325b (at time instance t0) and light indication 325b′ (at time instance t1) is larger than distance Da between light indications 325a and 325a′ (e.g. the distance the light indication progressed during time interval T).

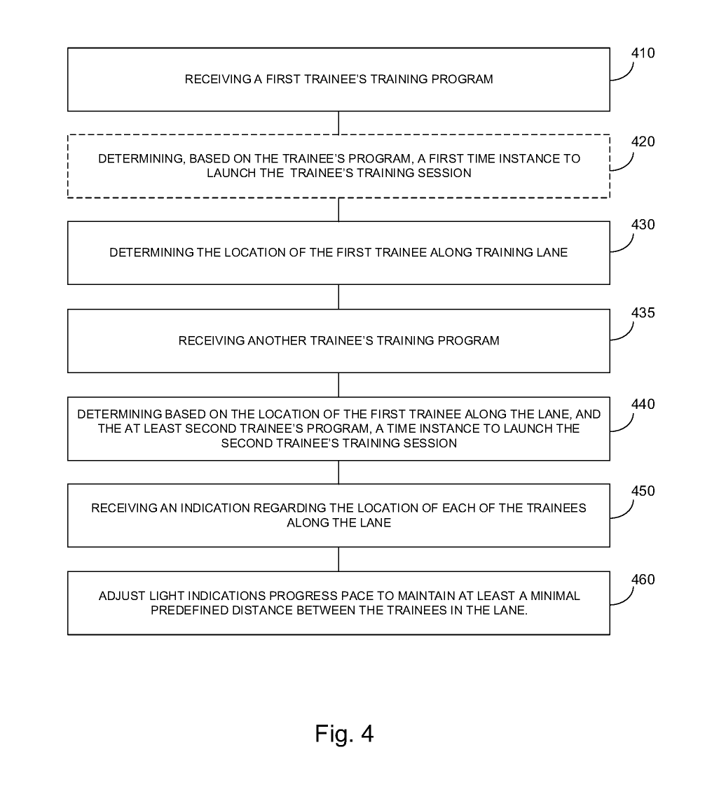

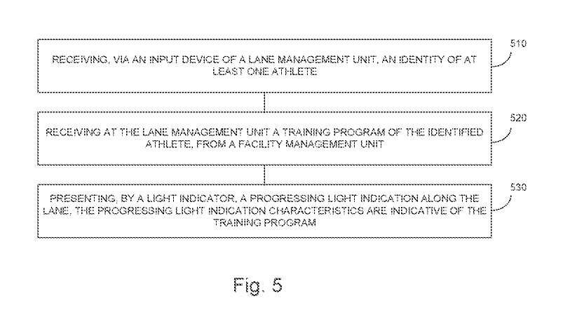

Reference is now made to FIG. 4 which is a flowchart of a method of training athletes. The method of FIG. 4 may be performed by a system such as system 100 or by any other system. As seen in block 410, some embodiments may include receiving at server 110 a trainee's training program. In block 420, some embodiments may include determining by for example controller 111, 121 or 131, based on the received trainees' programs, a time instance to launch the trainee's training session.

According to some embodiments, every predefined time interval after launch of the first training session, the location of the first trainee along training lane may be determined (block 430). The location of the trainee may be determined by receiving readings from one or more sensors, such as a camera(s), ultrasonic sensor(s) and the like, and processing the received readings to determine the location of the trainee. According to other embodiments, the location of the trainee may be determined via a Global Positioning System (GPS) device attached to the trainee. Other methods for determining the location of the trainee along the lone may be used.

In block 435 controller such as controller 111, 121 or 131 may receive another trainee's training program.

In block 440, based on the location of the first trainee along the lane, the first trainee's training program and the at least second trainee's program, a time instance to launch a second trainee's training session may be determined (e.g. by controller 121).

According to some embodiments, an indication regarding the location of each of the trainees along the lane may be received by lane management unit 130 and may be processed locally or sent to facility management unit 120 and/or server 110 via network 150 (block 450).

Based on the locations of the trainees along the lane (e.g. two or more trainees in a single lane), controller 131, 121 or 111 may adjust light indications progress pace to maintain at least a minimal predefined distance between the trainees in the lane (block 460).

For example, when the training facility is a swimming pool, and two trainees (i.e. swimmers) are supposed to train in a single lane, controller 131 may receive the identity of each of the swimmers via an NFC tag or card reader 136 and send the received identities to facility management unit 120. Facility management unit 120 may then send the identities of the swimmers in the lane to server 110 and receive in return the pre-stored training program of each swimmer Controller 111 in server 110 may further calculate and determine which swimmer should be launched first to his or her training session, and send an indication of the order of swimmers to lane management unit 130 (via facility management unit 120 or in some embodiments directly to lane management unit 130). Lane management unit 130 may then provide a signal to the first swimmer to launch his or her training session (e.g. a light signal, a sound or the like) and may monitor the progress (e.g. the location) of the swimmer along the lane. Once the first swimmer reaches a calculated distance from the pool edge, the second swimmer may be launched. The distance may be calculated according to the swimming style of each swimmer (e.g. breaststroke, free style, backstroke, butterfly etc.) the swimming pace or speed of each swimmer, the duration of training and the number of repetitions etc. Signaling unit 140 may provide each swimmer in the lane a unique indication of different parameters of the training program, such as, for example, swimming style, pace, progress, rest periods etc. It will be recognized that determining the location of each swimmer may provide an indication whether the swimmer follows the training program (e.g. follows the light indication provided by signaling unit 140) and may be used to determine whether changes or adjustments to one or more training program parameters may be required to maintain a minimal distance between swimmers in the lane.

According to some embodiments, when a trainee, such as a swimmer, requests to join a lane already used by one or more trainees, a similar method as described above may be used while block 420 may not be required.

A training program according to embodiments of the present invention may include at least one of sport type (e.g. running, swimming, bicycle riding, horseback riding etc.), style (e.g. swimming style, running style, horseback riding style etc.), speed or pace, number of repetitions, changes (e.g. in style, pace, number of repetitions and the like), duration of training session and duration of rest periods. A training program may include other or additional parameters.

Reference is made to FIG. 5 which is a flowchart of a method of training athletes. According to some embodiments the method may include receiving, via an input device of a lane management unit, an identity of at least one athlete (block 510). The identity of the at least one athlete may be received via an input device such as, for example, an NFC tag reader, an RFID reader, or any other input device suitable for inputting identification information such as a keyboard a touch screen and the like.

According to some embodiments, the method may further include receiving at the lane management unit a training program of the identified athlete, from a facility management unit (block 520); and presenting, by a light indicator, a progressing light indication along the lane, the progressing light indication characteristics may be indicative of the training program (block 530). According to some embodiments, the light indicator may include a plurality of LED strips parallel to each other and deployed along at least a portion of the lane. According to some embodiments, the progressing light indication characteristics may comprise at least two of: light progress speed; light color; light intensity; light color shade variation; and light pattern.

According to some embodiments, the training program may be received from a server computer in active communication with the facility management unit. The server computer may be in active communication with one or more user devices. According to some embodiments, the server computer may be adapted to store on a memory one or more training programs received from the at least one user devices.

Unless explicitly stated, the method embodiments described herein are not constrained to a particular order in time or chronological sequence. Additionally, some of the described method elements may be skipped, or they may be repeated, during a sequence of operations of a method.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

What is claimed is:

1. A training system for athletes, comprising:
at least one signaling unit;
at least one lane management unit; and
a facility management unit;
wherein the at least one signaling unit comprises:
a mounting device attachable to a surface of a training facility; and
an indicators carrier, attachable to the mounting device and configured to receive and retain at least two strips of indicators each strip comprising a plurality of light indicators;
wherein the at least one lane management unit comprises:
an input device;
an output device;
a processor; and
a communication unit in active communication with the signaling unit, and wherein the facility management unit comprises:
a communication channel configured to communicate with the at least one lane management unit and with a remote server computer; and
at least one processor;
wherein in operation the light indicators are adapted to present a progressing light indication, the progressing light indication characteristics are indicative of the training program of the athlete.

2. The system according to claim 1 wherein the progressing light indication characteristics comprise at least two of a list consisting of: light progress speed; light color; light intensity; light color shade variation; and light pattern.

3. The system according to claim 1 wherein the indicators carrier is attachable to the mounting device in a first position and in a second position, wherein in the first position the indicators are exposed and in the second position the indicators are enclosed between the carrier and the mounting device.

4. The system according to claim 1 wherein the input device is at least one of: a Near Field Communication (NFC) tag reader, and an RFID reader.

5. The system according to claim 1 wherein the output device is a screen.

6. The system according to claim 5 wherein the screen is a touchscreen.

7. The system according to claim 1 wherein the facility is a swimming pool and the mounting device is attachable to a bottom of the pool.

8. The system according to claim 7 wherein the training program comprises at least one of a swimming style, swimming speed, number of repetitions, progress in session, duration of training session and duration of rest periods.

9. The system according to claim 1 wherein the server computer comprising a processor, a memory and an input device, and wherein the server computer is in active communication with the at least one facility management unit.

10. The system according to claim 9 wherein the server computer is in active communication with one or more user devices and wherein the server computer is adapted to store on the memory one or more training programs received from the at least one user devices.

11. The system according to claim 10 wherein the server computer is adapted to send to one of the at least one facility management units a stored training program of an athlete.

12. The system according to claim 11 wherein the input device of the lane management unit is adapted to identify an athlete and send the identity of the athlete to the facility management unit via the communication channel.

13. The system according to claim 11 wherein the facility management unit is adapted to receive the training program of the athlete according to the identity of the athlete sent to the remote server computer from the facility management unit.

14. A method of training athletes comprising:
receiving at a facility management unit, a first trainee's training program and at least a second trainee's training program;
determining, by the facility management unit, the location of the first trainee along training lane; and
determining based on the location of the first trainee along the lane, the first trainee's training program and the at least second trainee's program, an at least second time instance to launch the second trainee's training session.

15. The method according to claim 14 further comprising receiving an indication regarding the location of each of the trainees along the lane; and adjusting light indications progress pace to maintain at least a minimal predefined distance between the trainees in the lane.

16. A method of training athletes comprising:
receiving, via an input device of a lane management unit, an identity of at least one athlete;
receiving at the lane management unit a training program of the identified athlete, from a facility management unit; and
presenting, by a light indicator, a progressing light indication along the lane, the progressing light indication characteristics are indicative of the training program.

17. The method according to claim 16 wherein the light indicator comprises a plurality of LED strips parallel to each other and deployed along at least a portion of the lane.

18. The method according to claim 16 wherein the input device is at least one of: a Near Field Communication (NFC) tag reader, and an RFID reader.

19. The method according to claim 16 wherein the training program is received from a server computer in active communication with the facility management unit, wherein the server computer is in active communication with one or more user devices and wherein the server computer is adapted to store on a memory one or more training programs received from the at least one user devices.

20. The method according to claim 16 wherein the progressing light indication characteristics comprise at least two of a list consisting of: light progress speed; light color; light intensity; light color shade variation; and light pattern.
